(19) United States
(12) Patent Application Publication
(10) Pub. No.: US 2026/0280190 A1
(43) Pub. Date: Sep. 17, 2026

(54) PULL-STRAP CONNECTOR WITH FIRST LIMITING PROTRUSION AND SECOND LIMITING PROTRUSION

(71) Applicant: DONGGUAN LUXSHARE TECHNOLOGIES CO., LTD, Dongguan City (CN)

(72) Inventors: Xuzong HUANG, Dongguan City (CN); Sihai YI, Dongguan City (CN); Zhaolong ZENG, Dongguan City (CN); Kaide WANG, Dongguan City (CN); Tengfang XIONG, Dongguan City (CN)

(73) Assignee: DONGGUAN LUXSHARE TECHNOLOGIES CO., LTD, Dongguan City (CN)

(21) Appl. No.: 19/373,901

(22) Filed: Oct. 30, 2025

(30) Foreign Application Priority Data
Mar. 13, 2025 (CN) 202510300779.7

(51) Int. Cl. H01R 13/633

(52) U.S. Cl. CPC H01R 13/6335

(57) ABSTRACT

A pull strap connector includes a body portion, an unlocking elastic piece and a pull strap. The unlocking elastic piece includes a first elastic arm and a second elastic arm. The pull strap is fastened to the unlocking elastic piece to drive the first elastic arm and the second elastic arm to undergo elastic deformation. The pull-strap connector further includes a first limiting protrusion and a second limiting protrusion. The first limiting protrusion is provided with a first limiting surface facing the second limiting protrusion. The second limiting protrusion is provided with a second limiting surface facing the first limiting protrusion. The pull strap is disposed adjacent to the first limiting surface and the second limiting surface. The pull strap is limited between the first limiting surface and the second limiting surface.

### CROSS-REFERENCE TO RELATED APPLICATION

This patent application claims priority of a Chinese Patent Application No. 202510300779.7, filed on March 13, 2025 and titled “PULL-STRAP CONNECTOR”, the entire content of which is incorporated herein by reference.

### TECHNICAL FIELD

The present disclosure relates to a pull-strap connector, belonging to the technical field of connectors.

### BACKGROUND

A pull-strap connector in the related art generally includes an insulating body, an unlocking elastic piece mounted on the insulating body, and a pull strap mating with the unlocking elastic piece. The unlocking elastic piece includes a first locking elastic arm and a second locking elastic arm. The pull strap directly or indirectly drives the unlocking elastic piece to elastically deform, so that the first locking elastic arm and the second locking elastic arm are thus disengaged from the locking position to realize unlocking with a mating connector.

However, the pull strap in the related art lacks a reliable limiting structure, which causes the pull strap to easily deflect when the pull strap is pulled. This deflection may cause the pull strap to be retained in a relevant gap, resulting in the pull strap to be stuck. In addition, such deflection may also cause a force applied to the unlocking elastic piece not to be located in a center of the unlocking elastic piece (for example, deflecting to one side), which causes the first locking elastic arm and the second locking elastic arm to fail to unlock simultaneously.

There is still room for improvement of the pull-strap connectors in the related art.

### SUMMARY

The present disclosure discloses a pull-strap connector, including: a body portion, the body portion including at least one tongue plate configured to mate with a mating connector; at least one surface of the tongue plate being provided with a conductive pad; the body portion defining a first slot and a second slot which are disposed at intervals in a first direction; an unlocking elastic piece, the unlocking elastic piece including a first elastic arm at least partially disposed in the first slot and a second elastic arm at least partially disposed in the second slot; the first elastic arm being provided with a first locking protrusion protruding beyond the body portion; the second elastic arm being provided with a second locking protrusion protruding beyond the body portion; the first locking protrusion and the second locking protrusion being configured to lock with the mating connector; and a pull strap, the pull strap being buckled on the unlocking elastic piece to drive the first elastic arm and the second elastic arm to elastically deform, thereby causing the first locking protrusion and the second locking protrusion to be disengaged from the mating connector; wherein the pull-strap connector further includes a first limiting protrusion and a second limiting protrusion which are disposed at intervals in the first direction; the first limiting protrusion includes a first limiting surface facing the second limiting protrusion; the second limiting protrusion includes a second limiting surface facing the first limiting protrusion; the pull strap disposed adjacent to the first limiting surface and the second limiting surface, and the pull strap is limited between the first limiting surface and the second limiting surface.

The present disclosure also discloses a pull-strap connector, including: a body portion, the body portion including at least one tongue plate; at least one surface of the tongue plate being provided with a conductive pad; an unlocking elastic piece, the unlocking elastic piece including a first elastic arm and a second elastic arm; the first elastic arm being provided with a first locking protrusion protruding beyond the body portion; the second elastic arm being provided with a second locking protrusion protruding beyond the body portion; and a pull strap, the pull strap being fastened to the unlocking elastic piece to drive the first elastic arm and the second elastic arm to elastically deform; wherein the pull-strap connector further includes a first limiting protrusion, a second limiting protrusion which are disposed at intervals in a first direction, and a space located between the first limiting protrusion and second limiting protrusion; the first limiting protrusion includes a first limiting surface facing the second limiting protrusion and exposed in the space; the second limiting protrusion includes a second limiting surface facing the first limiting protrusion and exposed in the space; the pull strap extends out of the body portion from the space, and the pull strap is limited between the first limiting surface and the second limiting surface along the first direction.

### BRIEF DESCRIPTION OF DRAWINGS

FIG. 1 is a perspective schematic view of a pull-strap connector in accordance with an embodiment of the present disclosure;

FIG. 2 is a perspective view of FIG. 1 from another angle;

FIG. 3 is a perspective view of FIG. 1 from another angle;

FIG. 4 is a top view of FIG. 1 from a certain angle;

FIG. 5 is a partially exploded view of FIG. 2;

FIG. 6 is a partially exploded view of FIG. 5 from another angle;

FIG. 7 is a partial enlarged view of circle part B in FIG. 5;

FIG. 8 is a partial enlarged view of circle part C in FIG. 6;

FIG. 9 is a further exploded perspective view of FIG. 5;

FIG. 10 is a perspective exploded view of FIG. 9 from another angle;

FIG. 11 is a perspective exploded view of FIG. 9 from another angle;

FIG. 12 is a plan view of a mutual positional relationship between a body portion and a pull strap in FIG. 11;

FIG. 13 is a perspective exploded view of the body portion and the pull strap;

FIG. 14 is a perspective exploded view of FIG. 13 from another angle; and

FIG. 15 is a cross-sectional view taken along line D-D in FIG. 4.

### DETAILED DESCRIPTION

Exemplary embodiments will be described in detail here, examples of which are shown in drawings. When referring to the drawings below, unless otherwise indicated, same numerals in different drawings represent the same or similar elements. The examples described in the following exemplary embodiments do not represent all embodiments consistent with this application. Rather, they are merely examples of devices and methods consistent with some aspects of the application as detailed in the appended claims.

The terminology used in this application is only for the purpose of describing particular embodiments, and is not intended to limit this application. The singular forms “a”, “said”, and “the” used in this application and the appended claims are also intended to include plural forms unless the context clearly indicates other meanings.

It should be understood that the terms “first”, “second” and similar words used in the specification and claims of this application do not represent any order, quantity or importance, but are only used to distinguish different components. Similarly, “an” or “a” and other similar words do not mean a quantity limit, but mean that there is at least one; “multiple” or “a plurality of” means two or more than two. Unless otherwise noted, “front”, “rear”, “lower” and/or “upper” and similar words are for ease of description only and are not limited to one location or one spatial orientation. Similar words such as “include” or “comprise” mean that elements or objects appear before “include” or “comprise” cover elements or objects listed after “include” or “comprise” and their equivalents, and do not exclude other elements or objects. The term “a plurality of” mentioned in the present disclosure includes two or more.

Hereinafter, some embodiments of the present disclosure will be described in detail with reference to the accompanying drawings. In the case of no conflict, the following embodiments and features in the embodiments can be combined with each other.

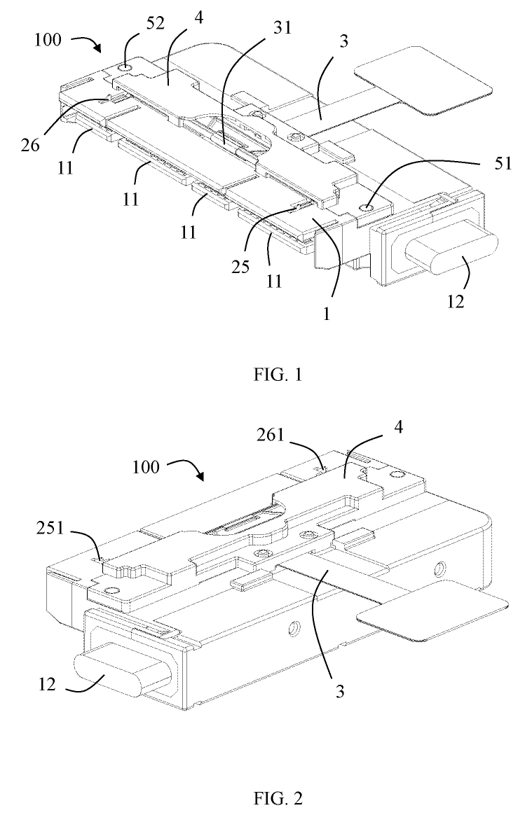

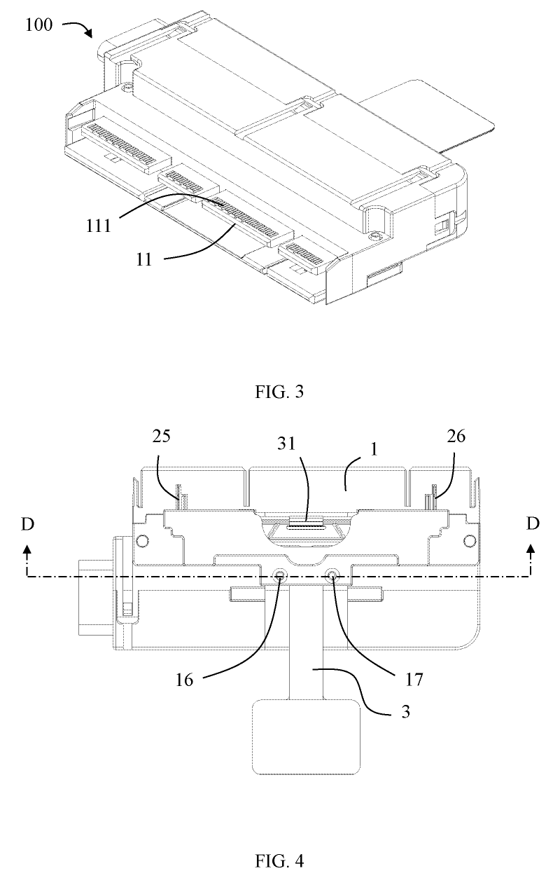

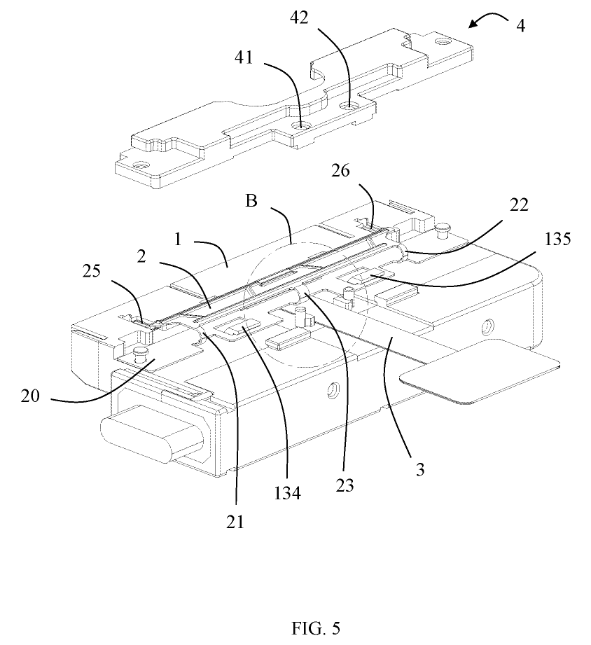

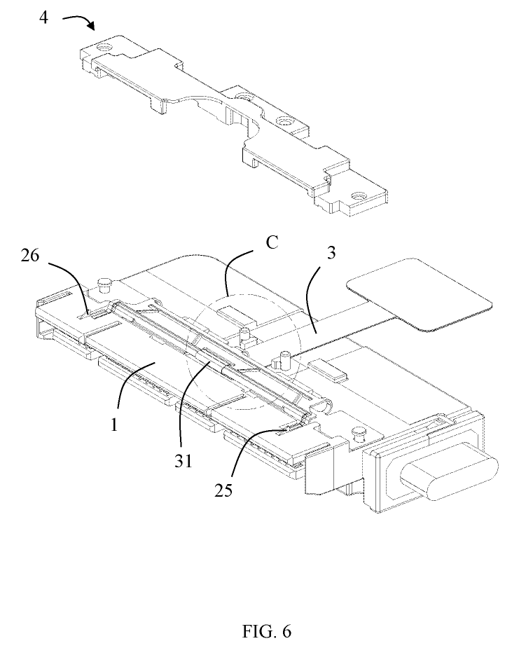

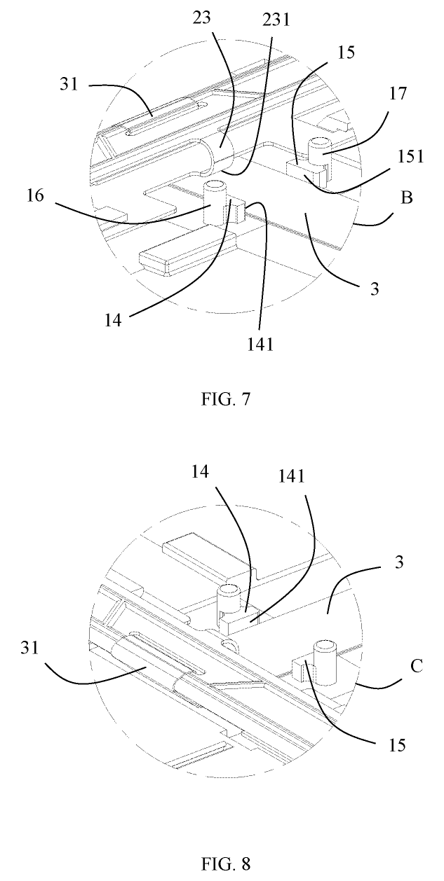

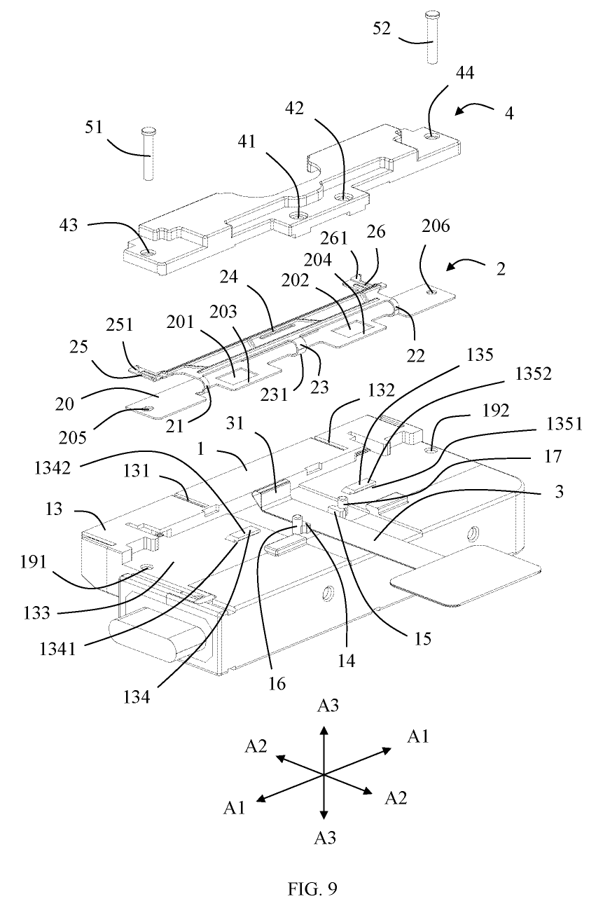

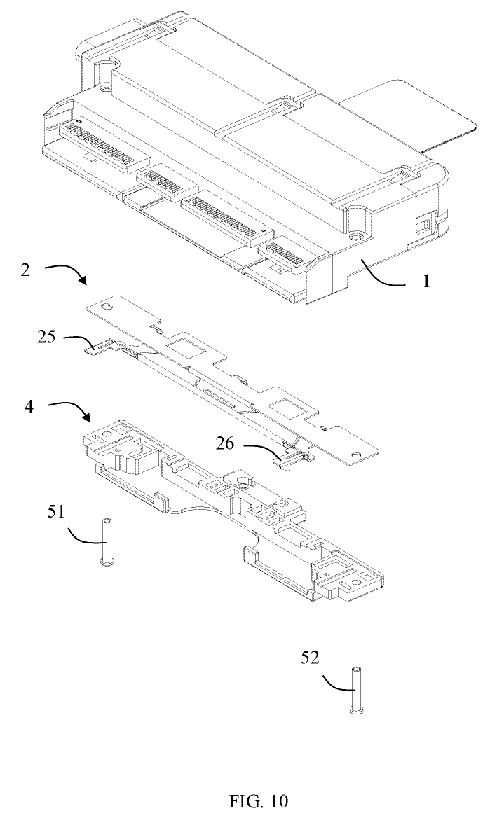

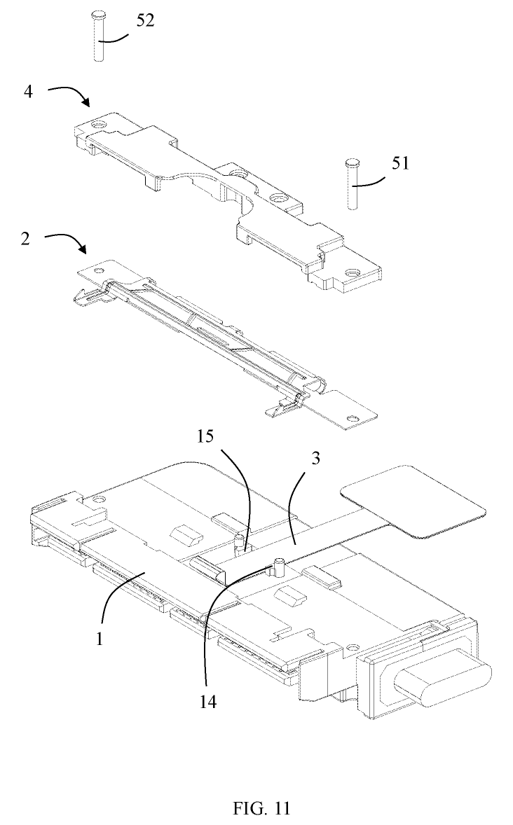

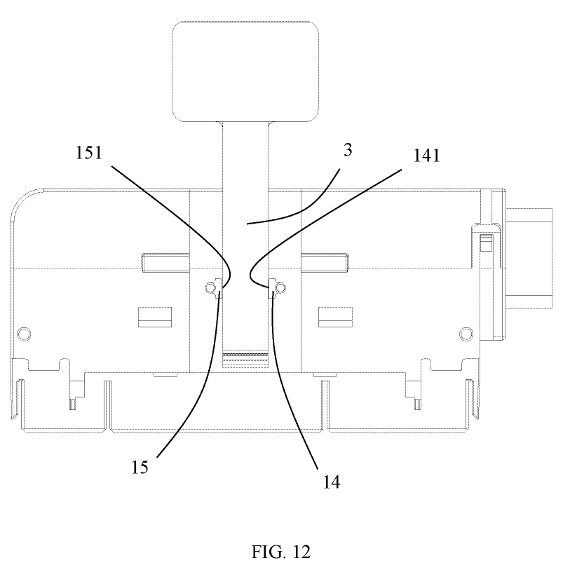

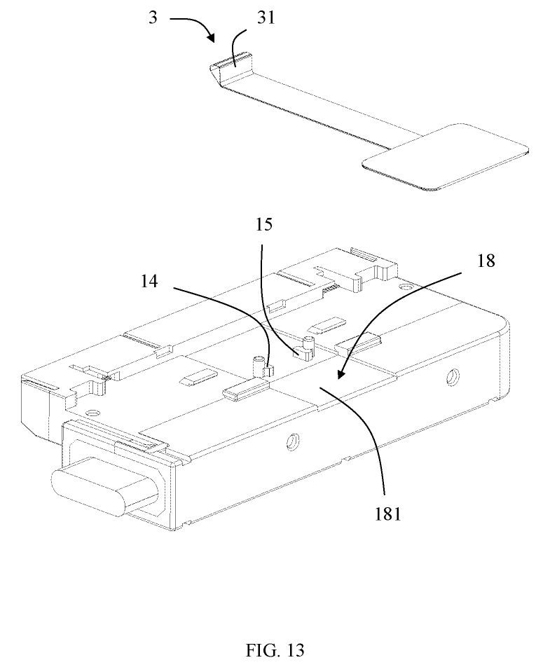

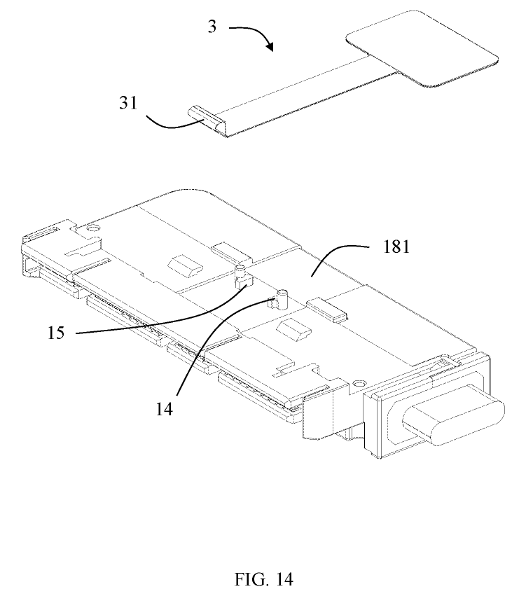

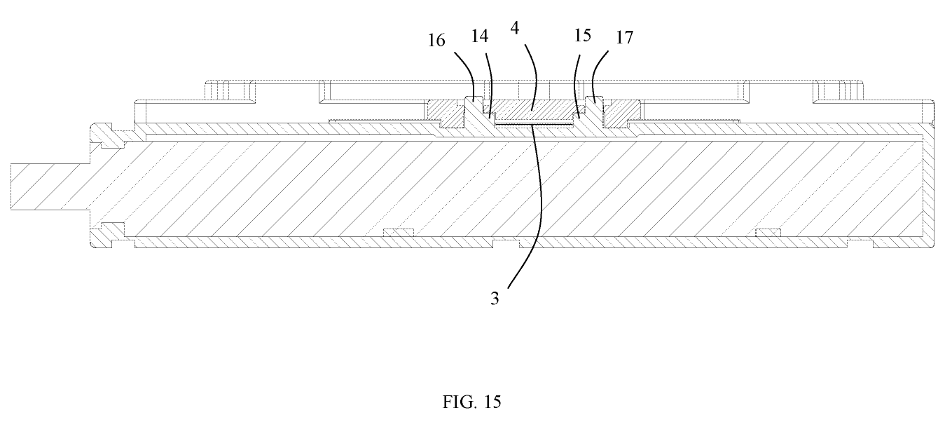

Referring to FIG. 1 to FIG. 15, the present disclosure discloses a pull-strap connector 100 including a body portion 1, an unlocking elastic piece 2 disposed on the body portion 1, a pull strap 3 connected to the unlocking elastic piece 2, and a cover plate 4 mating with the unlocking elastic piece 2.

In an illustrated embodiment of the present disclosure, the body portion 1 is provided with at least one tongue plate 11 arranged to mate with a mating connector (not shown). At least one surface of the tongue plate 11 is provided with a plurality of conductive pads 111. In the illustrated embodiment of the present disclosure, a plurality of tongue plates 11 are provided and are disposed at intervals along a first directions A1-A1 (for example, a left-right direction). Widths of the tongue plates 11 along the first directions A1-A1 are not uniformly the same.

In the illustrated embodiment of the present disclosure, the body portion 1 includes a built-in circuit board. The tongue plates 11 are formed by the built-in circuit board. The body portion 1 includes a cable 12 electrically connected (for example, soldered or welded) to the built-in circuit board.

In the illustrated embodiment of the present disclosure, the body portion 1 includes an insulating body 13. The insulating body 13 defines a first slot 131 and a second slot 132 which are disposed at intervals along the first direction A1-A1. In addition, the body portion 1 further includes a mounting wall 133 located at rear ends of the first slot 131 and the second slot 132. The mounting wall 133 includes a first fixing protrusion 134 and a second fixing protrusion 135. The first fixing protrusion 134 includes a first retaining groove 1341 and a first pressing portion 1342 located on a top of the first retaining groove 1341. The second fixing protrusion 135 includes a second retaining groove 1351 and a second pressing portion 1352 located on a top of the second retaining groove 1351. In the illustrated embodiment of the present disclosure, the first fixing protrusion 134 and the second fixing protrusion 135 are integrally formed with the mounting wall 133.

The pull-strap connector 100 further includes a first limiting protrusion 14 and a second limiting protrusion 15 which are disposed at intervals in the first directions A1-A1. The first limiting protrusion 14 is provided with a first limiting surface 141 facing the second limiting protrusion 15. The second limiting protrusion 15 is provided with a second limiting surface 151 facing the first limiting protrusion 14. The pull strap 3 is disposed adjacent to the first limiting surface 141 and the second limiting surface 151, and the pull strap 3 is limited between the first limiting surface 141 and the second limiting surface 151.

In the illustrated embodiment of the present disclosure, the first limiting protrusion 14 and the second limiting protrusion 15 are both integrally formed with the body portion 1. Of course, it is understandable to those skilled in the art that the first limiting protrusion 14 and the second limiting protrusion 15 may also be designed separately from the body portion 1. At this time, the first limiting protrusion 14 and the second limiting protrusion 15 is able to adopt a more flexible design as needed, and the material of the body portion 1 is not necessarily the same.

In the illustrated embodiment of the present disclosure, the body portion 1 is further provided with a first mounting post 16 and a second mounting post 17. The first mounting post 16 and the second mounting post 17 are both mating with the cover plate 4. In the illustrated embodiment of the present disclosure, the first mounting post 16 extends integrally with the first limiting protrusion 14, and the second mounting post 17 extends integrally with the second limiting protrusion 15.

In the illustrated embodiment of the present disclosure, the body portion 1 further defines a first fixing hole 191 and a second fixing hole 192. The first fixing hole 191 and the second fixing hole 192 both extend in a third direction A3-A3 (for example, a top-bottom direction).

The pull strap 3 extends in a second direction A2-A2 (for example, a front-rear direction). The body portion 1 is provided with a recess 18 for mating with the pull strap 3 and a mating surface 181 located at a bottom of the recess 18. The pull strap 3 is at least partially attached to the mating surface 181 in the second direction A2-A2. The mating surface 181 is a flat surface (with no segment difference). In this way, when the pull strap 3 is pulled by an external force, the movement of the pull strap 3 is smoother, and the pull strap 3 is not prone to folding. In the illustrated embodiment of the present disclosure, each two of the first direction A1-A1, the second direction A2-A2 and the third direction A3-A3 are perpendicular to each other.

In the illustrated embodiment of the present disclosure, the unlocking elastic piece 2 is made of a metal material. The unlocking elastic piece 2 includes a mounting portion 20 mounted to the body portion 1, a first bent portion 21 turned upwardly and bent forwardly from one side of the mounting portion 20, a second bent portion 22 turned upwardly and bent forwardly from another side of the mounting portion 20, an intermediate bent portion 23 turned upwardly and bent forwardly from a middle portion of the mounting portion 20, an urging portion 24 connected to the first bent portion 21, the second bent portion 22 and the intermediate bent portion 23, a first elastic arm 25 extending forwardly and integrally from the urging portion 24, and a second elastic arm 26 extending forwardly and integrally from the urging portion 24.

In the illustrated embodiment of the present disclosure, the mounting portion 20 defines a first hollow hole 201, a second hollow hole 202, a first retaining portion 203 located outside the first hollow hole 201, and a second retaining portion 204 located outside the second hollow hole 202. The first fixing protrusion 134 is at least partially received in the first hollow hole 201. The first retaining portion 203 is retained in the first retaining slot 1341. The first pressing portion 1342 presses against the first retaining portion 203 along the third direction A3-A3. The second fixing protrusion 135 is at least partially received in the second hollow hole 202. The second retaining portion 204 is retained in the second retaining slot 1351. The second pressing portion 1352 presses against the second retaining portion 204 along the third direction A3-A3.

In the illustrated embodiment of the present disclosure, the mounting portion 20 is in contact with the mounting wall 133. The mounting portion 20 defines a first hole 205 and a second hole 206.

The first elastic arm 25 is at least partially located in the first slot 131. The second elastic arm 26 is at least partially located in the second slot 132. The first elastic arm 25 is provided with a first locking protrusion 251 protruding beyond the body portion 1. The second elastic arm 26 is provided with a second locking protrusion 261 protruding beyond the body portion 1. The first locking protrusion 251 and the second locking protrusion 261 are configured to lock with the mating connector.

In the illustrated embodiment of the present disclosure, the intermediate bent portion 23 is located between the first bent portion 21 and the second bent portion 22 in the first direction A1-A1. The intermediate bent portion 23 is provided with an arc-shaped outer surface 231. The pull strap 3 mates with the arc-shaped outer surface 231 to improve the stability of the pull strap 3 when sliding. A width of the intermediate bent portion 23 in the first direction A1-A1 is greater than a width of the first bent portion 21 in the first direction A1-A1. The width of the intermediate bent portion 23 in the first direction A1-A1 is also greater than a width of the second bent portion 22 in the first direction A1-A1. By this arrangement, when the pull strap 3 is pulled, the strength of the intermediate portion of the unlocking elastic piece 2 can be increased, so as to prevent uneven force due to collapse and deformation at the intermediate portion. As a result, unlocking failure can be avoided. In addition, the first bent portion 21 and the second bent portion 22 located on two sides can provide better resilience force to the first elastic arm 25 and the second elastic arm 26 located on two sides, respectively.

In the illustrated embodiment of the present disclosure, the pull strap 3 is fastened to the urging portion 24 of the unlocking elastic piece 2 to drive the first elastic arm 25 and the second elastic arm 26 to undergo elastic deformation. The first locking protrusion 251 and the second locking protrusion 261 are thus disengaged from the mating connector to achieve unlocking. It is understandable to those of ordinary skill in the art that in the illustrated embodiment of the present disclosure, the pull strap 3 is directly fastened to the urging portion 24 of the unlocking elastic piece 2. When the illustrated embodiment shown in the present disclosure does not have a slider connected to the pull strap 3 and configured to resist against the unlocking elastic piece 2, the present disclosure simplifies the structure and improves reliability. In the illustrated embodiment of the present disclosure, when manually pressing by hand, the hand presses directly on the unlocking elastic piece 2.

In the illustrated embodiment of the present disclosure, the pull strap 3 includes a buckle portion 31 buckled on the urging portion 24. A portion connected to the buckle portion 31 passes out of the body portion 1 from a bottom of the mounting portion 20. With the first limiting protrusion 14 and the second limiting protrusion 15 on two sides, the present disclosure can ensure that the force acting on the first elastic arm 25 and the second elastic arm 26 is consistent, thereby facilitating the synchronous unlocking.

In the illustrated embodiment of the present disclosure, the cover plate 4 is fixed to the body portion 1. The unlocking elastic piece 2 is located at least partially between the cover plate 4 and the body portion 1. In one embodiment of the present disclosure, the cover plate 4 is made of an insulating material. The cover plate 4 is provided with a first mounting hole 41 and a second mounting hole 42. The first mounting post 16 is secured in the first mounting hole 41. The second mounting post 17 is secured in the second mounting hole 42. In one embodiment of the present disclosure, the first mounting post 16 is secured in the first mounting hole 41 in a hot melt manner. The second mounting post 17 is secured in the second mounting hole 42 in a hot melt manner.

In addition, the cover plate 4 further defines a first opening 43 and a second opening 44. The first opening 43, the first hole 205 and the first fixing hole 191 are aligned with one another. The second opening 44, the second hole 206 and the second fixing hole 192 are aligned with one another. The pull-strap connector 100 further includes a first fastener 51 inserted into the first opening 43, the first hole 205 and the first fixing hole 191 to be fixed with the body portion 1, and a second fastener 52 inserted into the second opening 44, the second hole 206 and the second fixing hole 192 to be fixed with the body portion 1. In one embodiment of the present disclosure, the first fastener 51 and the second fastener 52 are both screws.

Compared with the prior art, the pull-strap connector 100 disclosed in the present disclosure includes the first limiting protrusion 14 and the second limiting protrusion 15. The first limiting protrusion 14 is provided with the first limiting surface 141 facing the second limiting protrusion 15. The second limiting protrusion 15 is provided with the second limiting surface 151 facing the first limiting protrusion 14. The pull strap 3 is disposed adjacent to the first limiting surface 141 and the second limiting surface 151, and the pull strap 3 is limited between the first limiting surface 141 and the second limiting surface 151. In this way, the first limiting protrusion 14 and the second limiting protrusion 15 are able to limit the pull strap 3 to avoid the problem of unlocking failure caused by jamming or excessive deflection of the pull strap 3.

In addition, even if the pull strap 3 extending out of the body portion 1 is deflected when subjected to a force. At this time, a portion on the pull strap 3 between the first limiting protrusion 14 and the second limiting protrusion 15 can still be kept in a predetermined position due to the restrictions of the first limiting surface 141 and the second limiting surface 151. At this time, the portion where the external force is applied to the unlocking elastic piece 2 is still located in the middle of the unlocking elastic piece 2. Finally, the first elastic arm 25 and the second elastic arm 26 can be evenly stressed, thereby avoiding the problem that at least one of the first elastic arm 25 and the second elastic arm 26 cannot be unlocked due to deflection of the external force applied to the unlocking elastic piece 2.

The above embodiments are only used to illustrate the present disclosure and not to limit the technical solutions described in the present disclosure. The understanding of this specification should be based on those skilled in the art. Descriptions of directions, although they have been described in detail in the above-mentioned embodiments of the present disclosure, those skilled in the art should understand that modifications or equivalent substitutions can still be made to the application, and all technical solutions and improvements that do not depart from the spirit and scope of the application should be covered by the claims of the application.

What is claimed is:

1. A pull-strap connector, comprising:
a body portion, the body portion comprising at least one tongue plate configured to mate with a mating connector; at least one surface of the tongue plate being provided with a conductive pad; the body portion defining a first slot and a second slot which are disposed at intervals in a first direction;
an unlocking elastic piece, the unlocking elastic piece comprising a first elastic arm at least partially disposed in the first slot and a second elastic arm at least partially disposed in the second slot; the first elastic arm being provided with a first locking protrusion protruding beyond the body portion; the second elastic arm being provided with a second locking protrusion protruding beyond the body portion; the first locking protrusion and the second locking protrusion being configured to lock with the mating connector; and
a pull strap, the pull strap being buckled on the unlocking elastic piece to drive the first elastic arm and the second elastic arm to elastically deform, thereby causing the first locking protrusion and the second locking protrusion to be disengaged from the mating connector;
wherein the pull-strap connector further comprises a first limiting protrusion and a second limiting protrusion which are disposed at intervals in the first direction; the first limiting protrusion comprises a first limiting surface facing the second limiting protrusion; the second limiting protrusion comprises a second limiting surface facing the first limiting protrusion; the pull strap disposed adjacent to the first limiting surface and the second limiting surface, and the pull strap is limited between the first limiting surface and the second limiting surface.

2. The pull-strap connector according to claim 1, wherein the first limiting protrusion and the second limiting protrusion are both integrally formed with the body portion.

3. The pull-strap connector according to claim 1, wherein the pull strap extends in a second direction; the body portion comprises a mating surface that mates with the pull strap; a portion where the pull strap passes out of the first limiting protrusion and the second limiting protrusion in the second direction is at least partially in contact with the mating surface, and the mating surface is a flat surface.

4. The pull-strap connector according to claim 1, wherein the unlocking elastic piece comprises a mounting portion mounted to the body portion, a first bent portion that is turned and bent from one side of the mounting portion, a second bent portion that is turned and bent from another side of the mounting portion, and an urging portion connected to the first bent portion and the second bent portion; the first bent portion and the second bent portion are disposed at intervals in the first direction; the urging portion and the mounting part are disposed at intervals in a third direction; the first elastic arm and the second elastic arm are formed by extending integrally from the urging portion; the pull strap comprises a buckle portion buckled on the urging portion.

5. The pull strap connector according to claim 4, wherein a portion of the pull strap connecting to the buckle portion passes out of the body portion from a bottom of the mounting portion.

6. The pull-strap connector according to claim 4, wherein the unlocking elastic piece comprises an intermediate bent portion turned and bent from the mounting portion; the intermediate bent portion is located between the first bent portion and the second bent portion in the first direction; the intermediate bent portion is provided with an arc-shaped outer surface, and the pull strap mates with the arc-shaped outer surface.

7. The pull-strap connector according to claim 6, wherein a width of the intermediate bent portion in the first direction is greater than a width of the first bent portion in the first direction; the width of the intermediate bent portion in the first direction is greater than a width of the second bent portion in the first direction.

8. The pull-strap connector according to claim 4, wherein the mounting portion comprises a first hollow hole, a second hollow hole, a first retaining portion located outside the first hollow hole, and a second retaining portion located outside the second hollow hole;
the body portion comprises a first fixing protrusion and a second fixing protrusion; the first fixing protrusion comprises a first retaining groove and a first pressing portion; the second fixing protrusion comprises a second retaining groove and a second pressing portion;
the first fixing protrusion is at least partially received in the first hollow hole; the first retaining portion is retained in the first retaining groove; the first pressing portion presses against the first retaining portion in the third direction;
the second fixing protrusion is at least partially received in the second hollow hole; the second retaining portion is retained in the second retaining groove; the second pressing portion presses against the second retaining portion in the third direction.

9. The pull-strap connector according to claim 1, further comprising a cover plate fixed to the body portion; wherein the unlocking elastic piece is at least partially located between the cover plate and the body portion.

10. The pull-strap connector according to claim 9, wherein the body portion comprises a first mounting post and a second mounting post; the cover plate defines a first mounting through hole and a second mounting through hole; the first mounting post is secured in the first mounting through hole; the second mounting post is secured in the second mounting through hole.

11. The pull-strap connector according to claim 10, wherein the first mounting post extends integrally with the first limiting protrusion, and the second mounting post extends integrally with the second limiting protrusion.

12. The pull-strap connector according to claim 10, wherein the first mounting post is secured in the first mounting through hole in a hot melt manner, and the second mounting post is secured in the second mounting through hole in a hot melt manner.

13. The pull-strap connector according to claim 9, wherein the cover plate defines a first opening and a second opening; the unlocking elastic piece defines a first hole and a second hole; the body portion defines a first fixing hole and a second fixing hole; the first opening, the first hole and the first fixing hole are aligned with one another; the second opening, the second hole and the second fixing hole are aligned with one another;
the pull-strap connector further comprises a first fastener inserted into the first opening, the first hole and the first fixing hole to be fixed with the body portion, and a second fastener inserted into the second opening, the second hole and the second fixing hole to be fixed with the body portion.

14. A pull-strap connector, comprising:
a body portion, the body portion comprising at least one tongue plate; at least one surface of the tongue plate being provided with a conductive pad;
an unlocking elastic piece, the unlocking elastic piece comprising a first elastic arm and a second elastic arm; the first elastic arm being provided with a first locking protrusion protruding beyond the body portion; the second elastic arm being provided with a second locking protrusion protruding beyond the body portion; and
a pull strap, the pull strap being fastened to the unlocking elastic piece to drive the first elastic arm and the second elastic arm to elastically deform;
wherein the pull-strap connector further comprises a first limiting protrusion, a second limiting protrusion which are disposed at intervals in a first direction, and a space located between the first limiting protrusion and second limiting protrusion; the first limiting protrusion comprises a first limiting surface facing the second limiting protrusion and exposed in the space; the second limiting protrusion comprises a second limiting surface facing the first limiting protrusion and exposed in the space; the pull strap extends out of the body portion from the space, and the pull strap is limited between the first limiting surface and the second limiting surface along the first direction.

15. The pull-strap connector according to claim 14, wherein the first limiting protrusion and the second limiting protrusion are both integrally formed with the body portion.

16. The pull-strap connector according to claim 14, wherein the pull strap extends in a second direction; the body portion comprises a mating surface that mates with the pull strap; a portion where the pull strap passes out of the first limiting protrusion and the second limiting protrusion in the second direction is at least partially in contact with the mating surface, and the mating surface is a flat surface.

17. The pull-strap connector according to claim 14, wherein the unlocking elastic piece comprises a mounting portion mounted to the body portion, a first bent portion that is turned and bent from one side of the mounting portion, a second bent portion that is turned and bent from another side of the mounting portion, and an urging portion connected to the first bent portion and the second bent portion; the first bent portion and the second bent portion are disposed at intervals in the first direction; the urging portion and the mounting part are disposed at intervals in a third direction; the first elastic arm and the second elastic arm are formed by extending integrally from the urging portion; the pull strap comprises a buckle portion buckled on the urging portion.

18. The pull strap connector according to claim 17, wherein a portion of the pull strap connecting to the buckle portion passes out of the body portion from a bottom of the mounting portion.

19. The pull-strap connector according to claim 14, further comprising a cover plate fixed to the body portion; wherein the unlocking elastic piece is at least partially located between the cover plate and the body portion.

20. The pull-strap connector according to claim 19, wherein the body portion comprises a first mounting post and a second mounting post; the cover plate defines a first mounting through hole and a second mounting through hole; the first mounting post is secured in the first mounting through hole; the second mounting post is secured in the second mounting through hole;
wherein the first mounting post extends integrally with the first limiting protrusion, and the second mounting post extends integrally with the second limiting protrusion;
wherein the first mounting post is secured in the first mounting through hole in a hot melt manner, and the second mounting post is secured in the second mounting through hole in a hot melt manner.
